(19) United States
(12) Patent Application Publication
(10) Pub. No.: US 2021/0132221 A1
(43) Pub. Date: May 6, 2021

(54) 3D POSITIONING APPARATUS FOR UNDERWATER HIGH-PRESSURE WATER DECONTAMINATION NOZZLE

(71) Applicant: SOUTH CHINA UNIVERSITY OF TECHNOLOGY, Guangdong (CN)

(72) Inventors: Jiawei YE, Guangdong (CN); Shouqiang QIU, Guangdong (CN); Dongjiao WANG, Guangdong (CN); Fulin LIANG, Guangdong (CN)

(73) Assignee: SOUTH CHINA UNIVERSITY OF TECHNOLOGY, Guangdong (CN)

(21) Appl. No.: 16/491,569

(22) PCT Filed: Mar. 22, 2018
(86) PCT No.: PCT/CN2018/080097

§ 371 Date: Sep. 5, 2019

(30) Foreign Application Priority Data
Mar. 23, 2017 (CN) 201710176562.5

(51) Int. Cl. G01S 15/88; G01S 7/524; B08B 3/02

(52) U.S. Cl. CPC G01S 15/88; B08B 3/02; G01S 7/524

(57) ABSTRACT

The present invention discloses a 3D positioning apparatus for an underwater high-pressure water decontamination nozzle, which comprises a variable length water gun, a high-pressure water nozzle fixed to a front end of a gun barrel of the variable length water gun by a nozzle quick lock, and a high-pressure water intake pipe connected to a rear end of the gun barrel, the gun barrel being fixed to a gun body by a water gun quick lock, and further comprises an underwater sonar 3D positioning unit arranged on the gun body, The underwater sonar 3D positioning unit comprises a sonar signal generator, a power amplifier, a sonar having one transmitting unit and three receiving units distributed equidistantly along a circumference thereof, a signal amplifier, a distance identification and correction module, a temperature and salinity measurement module, and an alarm apparatus in circuit connection.

### TECHNICAL FIELD

The present invention relates to a 3D positioning apparatus for an underwater high-pressure water decontamination nozzle, and belongs to the field of marine underwater operation technologies.

### BACKGROUND

The demands for marine operation and marine oil and gas mining industry are increasing, and ships, marine equipment and marine oil and gas derricks have emerged in large numbers. It cannot be ignored that biological attachments represented by oyster greatly reduce the equipment performance in different forms. An underwater high-pressure water decontamination technology is used as a countermeasure technology. Since the diffusion of dirt is hindered in a water environment during operation, a diver suffers a poor sight condition, so that it is difficult to control a position of a nozzle, and inappropriate distance and angle of attack between a high-pressure water nozzle and an operation object will greatly reduce the operation efficiency. Compared with the positioning of a ground high-pressure water decontamination nozzle, the positioning accuracy of the nozzle during underwater operation is much worse, the nozzle is basically in a blind state, and the balance of the diver is easily broken under a counteractive load change, so as to be deviated greatly from the operation positions, so that the difficulty of the operation is greatly improved, or the operation efficiency is greatly reduced. The fact is that the existing underwater high-pressure water decontamination operation has high costs and poor economic benefits, and for the oil and gas mining industry, mining costs are increased and the competitiveness is reduced.

A specially designed 3D positioning apparatus is used in an underwater high-pressure water decontamination nozzle, which solves the problem of difficult position control of the nozzle by the diver. According to the technology, the position of the nozzle is assisted to be controlled by a 3D positioning mode which prompts a distance and an angle of attack between the nozzle and the operation object, so that the positioning capability and the operation efficiency of the underwater high-pressure water decontamination nozzle can be greatly improved, the energy consumption for decontamination and the labor intensity can be reduced, and the problem of low operation efficiency caused by difficulty in aligning targets due to blindness in turbid water can be effectively solved. This mode is obviously advanced in the efficiency and accuracy of underwater decontamination operation and has a great development prospect.

### SUMMARY

The object of the present invention is to provide a 3D positioning apparatus for an underwater high-pressure water decontamination nozzle, which uses 3D sonar ranging, temperature and salinity compensation and identification technology of turbid water waveform caused by dirt in decontamination with a specific high-pressure water gun, and solves the corresponding technical problems of poor operation reliability, low operation efficiency, high labor intensity and the like caused by difficulty in controlling the position of the nozzle under the condition of poor sight of a diver when a water environment hinders dirt diffusion during underwater high-pressure water decontamination operation.

The technical solutions of the present invention are as follows.

A 3D positioning apparatus for an underwater high-pressure water decontamination nozzle comprises a variable length water gun, a high-pressure water nozzle fixed to a front end of a gun barrel of the variable length water gun by a nozzle quick lock, and a high-pressure water intake pipe connected to a rear end of the gun barrel, the gun barrel is fixed to a gun body by a water gun quick lock, the 3D positioning apparatus for an underwater high-pressure water decontamination nozzle further comprises an underwater sonar 3D positioning unit arranged on the gun body, the underwater sonar 3D positioning unit comprises a sonar signal generator, a power amplifier, a sonar having a transmitting unit and three receiving units distributed equidistantly along a circumference thereof, a signal amplifier, a distance identification and correction module, a temperature and salinity measurement module, and an alarm apparatus in circuit connection; the sonar signal generator amplifies a generated sonar signal by the power amplifier and transmits the amplified sonar signal by the transmitting unit of the sonar; the signal amplifier amplifies a sonar reflecting signal received by the receiving unit of the sonar and transmits the amplified sonar reflecting signal to the distance identification and correction module; the temperature and salinity measurement module is used for detecting salinity and temperature information in a water area and transmitting salinity and temperature information to the distance identification and correction module; the distance identification and correction module obtains current 3D real-time positions of the high-pressure water nozzle and an operation object by identifying the amplified sonar reflecting signal and combining compensation of the salinity and temperature information, and simultaneously compares the current 3D real-time positions with corresponding standard operation positions; and the alarm apparatus is used for displaying the current 3D real-time positions of the current high-pressure water nozzle and the operation object, and alarming over-distance and less-distance and recording according to a comparison result between the current 3D real-time positions and the corresponding standard operation positions.

Further, the sonar signal generator comprises an oscillating circuit and a time base circuit, the oscillating circuit is used for forming a sonar pulse, and a width and a number of the sonar pulse are controllable; and the time base circuit is used for controlling a sonar pulse frequency reference.

Further, when the current 3D real-time positions is larger than the corresponding standard operation positions, the alarm apparatus performs over-distance alarming, otherwise, performs less-distance alarming.

Further, the temperature and salinity measurement module comprises a temperature sensor and a salinity sensor.

Further, the 3D real-time positions comprise a current distance between the high-pressure water nozzle and the operation object, and a current angle of attack between the high-pressure water nozzle and the operation object.

Compared with the prior art, the present invention has the following beneficial effects: according to the technical solution, the positioning reliability is greatly improved by the 3D positioning technology of the underwater high-pressure water decontamination nozzle, so that the operation accuracy, the operation efficiency and the operation safety are improved, and the problem of underwater decontamination operation is well solved.

### BRIEF DESCRIPTION OF THE DRAWINGS

The invention is further described hereinafter with reference to the accompanying drawings and the embodiments.

FIG. 1 is a structure diagram of a 3D positioning apparatus for an underwater high-pressure water decontamination nozzle according to the embodiment of the present invention.

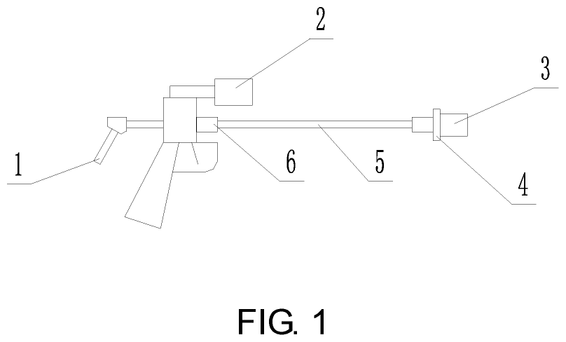

FIG. 2 is a diagram illustrating composition of an underwater sonar 3D positioning unit according to the embodiment of the present invention.

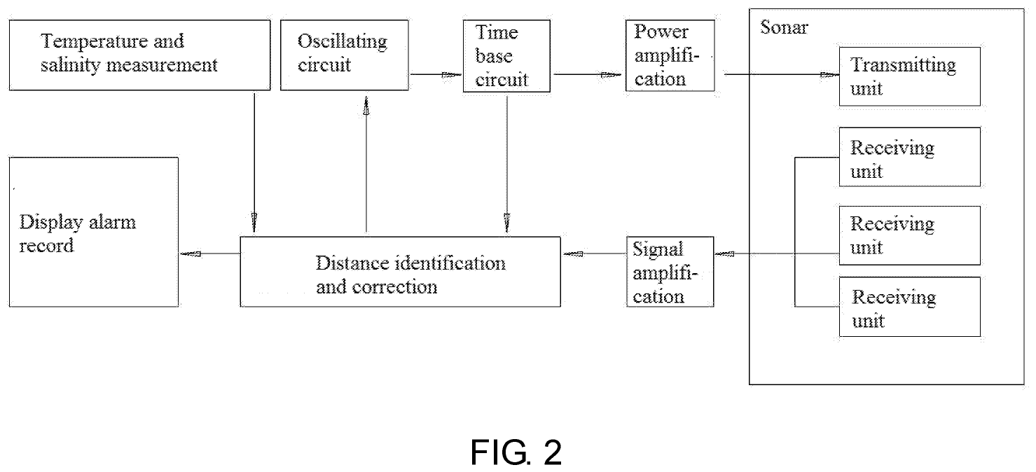

In the drawings:
1 refers to high-pressure water intake pipe,
2 refers to underwater sonar 3D positioning unit,
3 refers to high-pressure water nozzle,
4 refers to nozzle quick lock,
5 refers to variable length water gun, and
6 refers to water gun quick lock.

### DETAILED DESCRIPTION

The technical solutions of the invention are further described hereinafter with reference to the accompanying drawings.

A 3D positioning apparatus for an underwater high-pressure water decontamination nozzle comprises a variable length water gun 5, a high-pressure water nozzle 3 fixed to a front end of a gun barrel of the variable length water gun 5 by a nozzle quick lock 4, and a high-pressure water intake pipe 1 connected to a rear end of the gun barrel, the gun barrel is fixed to a gun body by a water gun quick lock 6, wherein the 3D positioning apparatus for an underwater high-pressure water decontamination nozzle further comprises an underwater sonar 3D positioning unit 2 arranged on the gun body. The underwater sonar 3D positioning unit 2 comprises a sonar signal generator, a power amplifier, a sonar having a transmitting unit and three receiving units distributed equidistantly along a circumference thereof, a signal amplifier, a distance identification and correction module, a temperature and salinity measurement module, and an alarm apparatus in circuit connection. The sonar signal generator amplifies a generated sonar signal by the power amplifier and transmits the amplified sonar signal by the transmitting unit of the sonar. The signal amplifier amplifies a sonar reflecting signal received by the receiving unit of the sonar and transmits the amplified sonar reflecting signal to the distance identification and correction module. The temperature and salinity measurement module is used for detecting salinity and temperature information in a water area and salinity measurement module is located and transmitting salinity and temperature information to the distance identification and correction module. The distance identification and correction module obtains current 3D real-time positions of the high-pressure water nozzle and an operation object by identifying the amplified sonar reflecting signal and combining compensation of the salinity and temperature information, and simultaneously compares the current 3D real-time positions with corresponding standard operation positions. The 3D real-time positions comprise a current distance between the high-pressure water nozzle and the operation object, and a current angle of attack between the high-pressure water nozzle and the operation object. The alarm apparatus is used for displaying the current 3D real-time positions of the current high-pressure water nozzle and the operation object, and alarming over-distance and less-distance and recording according to a comparison result between the current 3D real-time positions and the corresponding standard operation positions.

The sonar signal generator comprises an oscillating circuit and a time base circuit, the oscillating circuit is used for forming a sonar pulse, and a width and a number of the sonar pulse are controllable; and the time base circuit is used for controlling a sonar pulse frequency reference.

When the current 3D real-time positions is larger than the corresponding standard operation positions, the alarm apparatus performs over-distance alarming, otherwise, performs less-distance alarming. In case of over-distance alarming, the operator can reduce the distance between the high-pressure water nozzle and the operation object, and/or the angle of attack between the high-pressure water nozzle and the operation object in time until the alarming is eliminated; and in case of less-distance alarming, the operator can increase the distance between the high-pressure water nozzle and the operation object, and/or the angle of attack between the high-pressure water nozzle and the operation object in time until the alarming is eliminated. This embodiment assists in controlling the position of the high-pressure water nozzle by prompting the 3D real-time positions of the high-pressure water nozzle and the operation object, which will greatly improve the positioning capability and operation efficiency of the underwater decontamination high-pressure water nozzle, reduce the energy consumption for decontamination and labor intensity, effectively solve the problem of low operation efficiency caused by difficulty in aligning targets due to blindness in turbid water, and guide the operation in real time. This mode has obvious advantages in terms of underwater decontamination operation efficiency and operation accuracy.

The temperature and salinity measurement module comprises a temperature sensor and a salinity sensor, water temperature and salinity in current operation water area are monitored in real time, because the water temperature and salinity can have a certain impact on sound propagation under water, a sound velocity is compensated by water temperature and salinity information obtained by the temperature sensor and the salinity sensor, thus improving accuracy and precision of results.

Corresponding standard operation positions are determined by a specific high-pressure water gun structure, a high-pressure water parameter, an operation water depth and other requirements, a characteristic of the turbid water caused by dirt during decontamination is related to the specific high-pressure water gun structure and the nozzle, an effectiveness of 3D positioning is determined by comprehensive effects of functional devices of the high-pressure water intake pipe, the high-pressure water nozzle, the nozzle quick lock, the variable length water gun and the water gun quick lock with different structures and different operation principles, 3D positioning of the high-pressure water nozzle and the operation object is calibrated by the parameters above to obtain standard operation positions meeting the current requirements, which is important reference data for realizing the effectiveness of underwater sonar 3D positioning under corresponding working conditions.

It shall be understood that the application of the invention is not limited to the detailed description above, and those of ordinary skills in the art can make improvements or changes according to the description above. All the improvements or changes shall fall within the protection scope of the claims of the invention.

1. A 3D positioning apparatus for an underwater high-pressure water decontamination nozzle, comprising:
a variable length water gun;
a high-pressure water nozzle fixed to a front end of a gun barrel of the variable length water gun by a nozzle quick lock; and
a high-pressure water intake pipe connected to a rear end of the gun barrel, the gun barrel being fixed to a gun body by a water gun quick lock; and
an underwater sonar 3D positioning unit arranged on the gun body,
wherein the underwater sonar 3D positioning unit comprises:
a sonar signal generator;
a power amplifier;
a sonar having a transmitting unit and three receiving units distributed equidistantly along a circumference thereof;
a signal amplifier;
a distance identification and correction module;
a temperature and salinity measurement module; and
an alarm apparatus in circuit connection,
wherein the sonar signal generator amplifies a generated sonar signal by the power amplifier and transmits the amplified sonar signal by the transmitting unit of the sonar; the signal amplifier amplifies a sonar reflecting signal received by the receiving unit of the sonar and transmits the amplified sonar reflecting signal to the distance identification and correction module; the temperature and salinity measurement module is used for detecting salinity and temperature information in a water area and transmitting salinity and temperature information to the distance identification and correction module; the distance identification and correction module obtains current 3D real-time positions of the high-pressure water nozzle and an operation object by identifying the amplified sonar reflecting signal and combining compensation of the salinity and temperature information, and simultaneously compares the current 3D real-time positions with corresponding standard operation positions; and the alarm apparatus is used for displaying the current 3D real-time positions of the current high-pressure water nozzle and the operation object, and alarming over-distance and less-distance and recording according to a comparison result between the current 3D real-time positions and the corresponding standard operation positions.

2. The 3D positioning apparatus for an underwater high-pressure water decontamination nozzle according to claim 1, characterized in that, wherein the sonar signal generator comprises an oscillating circuit and a time base circuit, the oscillating circuit is used for forming a sonar pulse, and a width and a number of the sonar pulse are controllable; and the time base circuit is used for controlling a sonar pulse frequency reference.

3. The 3D positioning apparatus for an underwater high-pressure water decontamination nozzle according to claim 1, wherein when the current 3D real-time positions between the current high-pressure water nozzle and the operation object is larger than the corresponding standard operation positions between the current high-pressure water nozzle and the operation object, the alarm apparatus performs over-distance alarming, otherwise, performs less-distance alarming.

4. The 3D positioning apparatus for an underwater high-pressure water decontamination nozzle according to claim 1, wherein the temperature and salinity measurement module comprises a temperature sensor and a salinity sensor.

5. The 3D positioning apparatus for an underwater high-pressure water decontamination nozzle according to claim 1, wherein the 3D real-time positions comprise a current distance between the high-pressure water nozzle and the operation object, and a current angle of attack between the high-pressure water nozzle and the operation object.
